(19) United States
(12) Patent Application Publication
(10) Pub. No.: US 2006/0074791 A1
(43) Pub. Date: Apr. 6, 2006

(54) System, method and associated software for managing the transportation of goods

(76) Inventor: John A. Jelaco, Coto de Caza, CA (US)

Correspondence Address: KOPPEL, JACOBS, PATRICK & HEYBL, 555 ST. CHARLES DRIVE, SUITE 107, THOUSAND OAKS, CA, 91360, US

(21) Appl. No.: 10/953,316

(22) Filed: Sep. 28, 2004

(51) Int. Cl. G06Q 40/00

(52) U.S. Cl. 705/37

(57) ABSTRACT

A macro-collaboration solution is provided through which trading partners in the transportation and logistics industry can efficiently exchange contractual, order and financial information facilitating the movement of shipments over the road, or through intermodal means. A combination of web portals and wireless devices are leveraged by this marketplace to offer trading partners a means for real-time acquisition of information critical to supply chain, decision support, shipment visibility, asset tracking, and exception management.

### BACKGROUND OF THE INVENTION

1. Field of the Invention

The invention relates generally to the goods transportation industry and, more particularly, to systems, methods and software for managing such transportation among industry participants, including carriers, shippers and retailers.

“Carriers” (a.k.a. “service providers”) provide shipment transportation services from one location to another and may include, for example, trucking companies or railroad companies. Carriers provide the power, i.e., tractor and driver, to move the shipments and can also provide the equipment, e.g., trailer. They also manage the load once it's been dispatched. “Shippers” are the source and sender of the goods being shipped. They respond to the orders that buyers generate and determine if they need transportation resources in order to complete the shipment request. Shippers contact carriers to perform the shipment transport from their shipping location/facility to the buyer's requested delivery location. “Retailers” are the destination of the goods being shipped.

2. Description of Related Art

Currently, cartage or smaller carriers perform both intermodal services and over the road (OTR) with high costs in personnel management. The majority of smaller carrier infrastructures operate with just a phone and a desktop to support their day-to-day business. Due to high volume of manual work, personnel tend to work inefficiently and are barely able to keep up with the manual management of the land transportation load move.

Supply chain management today mandates increased shipment visibility, tracking and key milestone information to effectively manage exceptions and take advantage of cost opportunities. Today's truckload technology and tracking abilities allow OTR truckers to always know location and status of freight, allowing proactive equipment management. Carrier's use tracking equipment such as cellular phones, PDA devices, and global positioning systems (GPS). But even with these tracking devices, most carriers still manually gather data. Intermodal management is even more involved as now the carrier is required to track load information from the rail as well.

The reliance on manual intervention as well as other burdens placed on the carrier's personnel can translate to invalid or no data reported and late information, ultimately leading to additional costs to the carrier. The following exemplifies this point.

While out-gates or in-gates are reported, customer movements and status changes can be lacking or undocumented. In most cases, cross towns, terminations, flying interchanges, equipment utilization, dock time, service requirements, overages, shortages, and damages go unreported. This lack of information leaves customers questioning a shipment's true status: was it a service failure or an on-time delivery with a reporting oversight. Because this data still must be manually entered into the carrier's system, the 3d party will not necessarily have access to their information within a timely fashion. Timing problems adversely impact a shipper of record's ability to manage their empty equipment creating delays that impact them from days to weeks. Delays involving empty equipment result in deadhead or empty miles for the carrier money spent for no work/income to the company.

With current trends and continuation of manual procedures, increasing demands on the carriers will lead to more customer service failures ultimately leaving shippers with weaker and less valuable relationships with their core carrier base.

A need for automated collection of information related to the transport of goods has been recognized along with a need for providing such information to, and sharing such information among, industry participants. The need for automatically facilitating partnerships among industry participants has also been recognized. The invention fulfills these needs and others.

### SUMMARY OF THE INVENTION

The system, method and associated software of the invention provide a macro-collaboration solution through which trading partners in the transportation and logistics industry can efficiently exchange contractual, order, and financial information facilitating the movement of shipments over the road, or through intermodal means. A combination of web portals and wireless devices are leveraged by this marketplace to offer trading partners a means for real-time acquisition of information critical to supply chain, decision support, shipment visibility, asset tracking, and exception management.

The invention includes may aspects and facets that relate to the shipment of goods. For example, in one aspect, the invention relates to a method of using a computer network including a server, database and user terminal to arrange for the shipment of goods for a party. In the method, the party is associated, through a database component, with a plurality of lanes along which the party may desire to transport goods. A plurality of core service providers is associated, also through a database component, with the party. This association includes data indicative of a commitment of a quantity of shipment orders the party expects to dispatch to the core provider for a particular lane. A shipment order screen including a menu of the lanes associated with the party is presented at the user terminal. A shipment order from the user terminal is received at the server. This order includes data indicative of a lane selected by the user. In response to this order, the database is searched for core service providers with which the party has an unfilled commitment quantity for the selected lane and data indicative of the located core service providers is outputted to the user terminal.

The invention also related to systems and computer readable media that perform the associated methods. For example, a system for arranging for the shipment of goods for a party includes a database that associates the party with lanes and a plurality of core service providers with the party, in a manner as described in the above method. The system also includes a user terminal that is programmed to present a shipment order screen including a menu of the lanes associated with the party and to output data indicative of a shipment order. The system further includes a server that is programmed to receive the shipment order from the user terminal, including data indicative of a selected lane; search the database for core service providers with which the party has an unfilled commitment quantity for the selected lane; and output to the user terminal, data indicative of the located core service providers.

In another of its facets, the invention relates to a computer-readable medium having computer-executable instructions for performing the above method. As used herein, a computer-readable medium includes any kind of computer memory such as floppy disks, conventional hard disks, CD-ROMS, Flash ROMS, nonvolatile ROM and RAM.

Other aspects of the invention related to methods, systems and computer-readable media that track the movement of goods during shipment, monitor and rate the performance of service providers and manage the shipment of goods between origin. The shipment management feature includes the provision of various notifications and alerts with respect to the progress or delay of the shipment and, if there is a delay, the reason or reasons for the delay.

These and other aspects and advantages of the invention will become apparent from the following detailed description and the accompanying drawings which illustrate by way of example the features of the invention.

### BRIEF DESCRIPTION OF THE DRAWINGS

FIG. 1 is a block diagram of an exemplary system configured in accordance with the invention including a main server (with a database) interfacing with a carrier user terminal, a shipper user terminal, a third party logistics (3PL) provider user terminal, a retailer user terminal and a system administrator terminal over a computer network and with a driver wireless appliance and a trailer device over a wireless network. Also, in this diagram note the interchange of data taking place between the carrier/shipper/retailer back office system and the system's back office system, indicating electronic movement of documents such as tendered orders, status updates, invoices, and driver pay.

FIG. 2 is a general diagram of an exemplary software/hardware model for the system of FIG. 1.

FIG. 3 is a representation of a lane between an origin and a destination.

FIG. 4 is a flow chart of a process by which the system uses information from its user terminals and within its database to search for a carrier.

FIG. 5 is a representation of various stages of a shipment cycle from the perspective of the wireless appliance device in FIG. 1 including an enforcement model of the system that controls the presentations through, and collection of information from, the wireless appliance device.

FIG. 6 is a representation of various lanes and associated lane segments between an origin and destination.

### DETAILED DESCRIPTION OF THE PREFERRED EMBODIMENTS

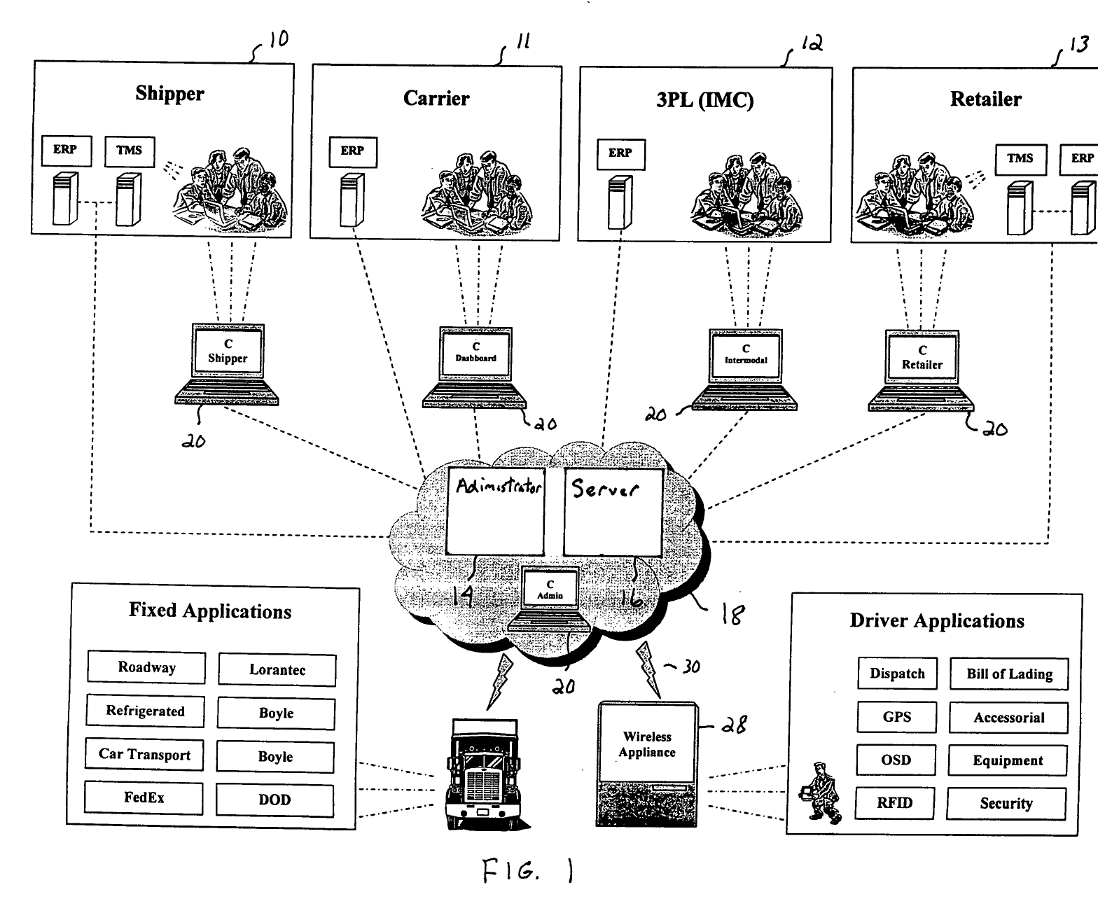

With reference to FIG. 1, there is shown a transportation management system including a number of user sites 10, 11, 12, 13, 14 interfacing with a main server 16 through an information network 18. The network 18 may be, for example, the Internet or alternatively a local area network. The user sites may include a shipper site 10, a carrier or service provider site 11, a third party logistics (3PL) site 12, a retailer site 13 and a system administrator site 14. Each of these sites includes an interface device 20 through which users access the main server 16. The system is mirrored (with a back-up system) be running a server such as Tomcat or J2EE compliant server such as BEA Weblogic or JBoss. The main server 16 has at a minimum 3 GB RAM 2 GHz process or speed and at least an 80 GE Hard Disk. In one configuration, the operating system is Linux/UNIX, although other systems may be used. The user sites 10, 11, 12, 13, 14 or workstations may have any operating system that supports a standard web browser such as IE or Netscape. The workstations have, at a minimum, 256 MB of RAM and an operating speed of 600 MHz.

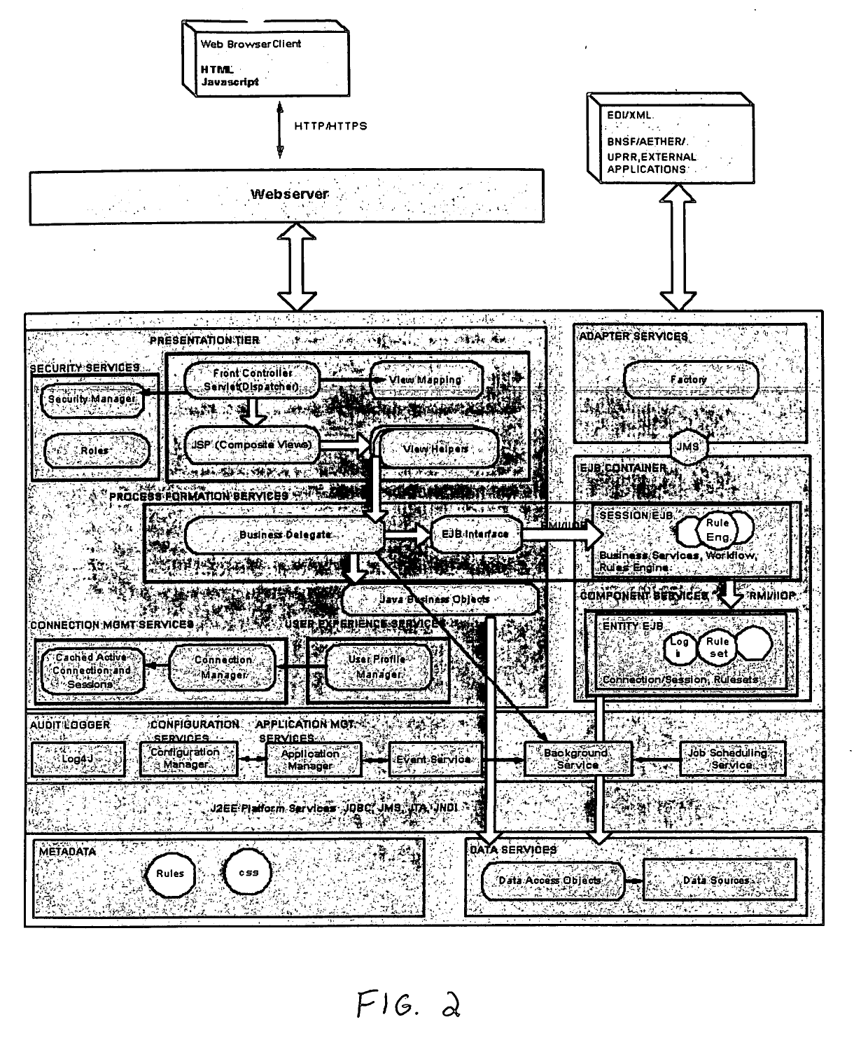

Resident at the main server 16 is software including a shipper software component, a service provider software component, a 3PL software component, a retailer software component and an administrator software component. Users access the software through, for example, Web portals presented through their respective user interfaces. These software components and portals are referred to as the CShipper™, CDashboard™, Clntermodal™, CRetailer™, and CAdmin™ software components or portals. The system software is based on J2EE compliant standards, and used JsPs for web access and EJBs for business logic as well as database access. The database used in the system may be a MS SqlServer 2000, a current version of Oracle or any other database with sufficient capabilities. FIG. 2 is a general diagram of the system software/hardware model.

The CDashboard software component allows over-the-road (OTR) carriers to manage their dispatches while at the same time perform data exchange transactions with their contracted shippers/retailers. It also allows carriers to manage their power and equipment and communicate their equipment capacity to their contracted shippers/retailers as well. Other functions incorporated in this software package include: reporting mechanisms and EDI specifications, carriers/credit information, review of delivery issues, shippers profile and rating, planning tools, visibility of orders and commitment, asset unitization program, centralized paperwork access, repositioning opportunities report, bobtailing and deadhead lanes, dwell time analysis, available equipment by desirable lanes, access to spot market and dynamic pricing, cash flow projections and analysis, single source for freight payment from shipper and turnaround on billing cycle.

The CDashboard software component includes various modules and applications as listed below:

| Module | Application |
|---|---|
| Dashboard | Shipment |
| | Exception Message/Alerts |
| | Equipment |
| | Lane Capacity |
| | Driver |
| | Detention/Storage |
| | Billing |
| Accounts | Company |
| | User |
| | Location |
| | Power Tractor/Driver |
| | Equipment |
| | Lanes (view only) |
| | Event (view only) |
| | Contract (view only) |
| | Pool |
| | Detention |
| | Storage |
| Customer Service | Dispatch Pending/Tendered |
| Dispatch | Ready Dispatch |
| | Power Capacity |
| Capacity | Lane Capacity |
| Spot Market | Spot Market |
| Shipment Management | Shipment Management (Structure) |
| | Shipment Management (Setup) |
| Freight Billing | Invoicing |
| | Account Integration |
| | EDI Integration |
| | Reports (Unbilled) |
| | Reports (Daily Sales) |
| Billing | Driver Pay Setup |
| | Driver Deduction Setup |
| | Driver Pay Approval |
| | Driver Pay Processing |
| | Accounting Integration |
| | Driver Pay Reports (Driver Overpay) |

Associated with each of these applications are functional requirements. A description of some of these function requirements is included in the following description of the system. A more detailed list of functional requirements for the CDashboard software component is included in Appendix A.

The CShipper software components and the CRetailer software components gives shippers and retailers the ability to determine capacity issues involved with creating shipment tenders. These modules also allow the shipper/retailer to tender directly to their core carrier base and still monitor their capacity/commitment ratios per location—all of these actions are seamlessly integrated with real-time data to the shipper. They also provide for: daily-automated tendering, receipt and confirmation, planning tools, multimode analysis of transportation cost between all providers, centralized use of desktop information by site (web-enable mobile), decision report tools (analyze service provider performance, costs by site by lane by receiver, yield management report), planning tools (visibility of capacity by core carriers and their commitment), information management, search for available spot pricing cost sharing capabilities, POD retrieval system, track and trace capabilities (real time).

The CShipper and CRetailer software components includes various modules and applications as listed below:

| Module | Application |
|---|---|
| Desktop | Shipment |
| | Exception Message/Alerts |
| | Freight Payment |
| | Orders |
| | Lane |
| Accounts | Company Setup |
| | User Access (Session) |
| | User Access (Setup) |
| | Location Setup |
| | Lanes Setup |
| | Event Setup |
| | Contract Setup |
| Shipment | Order (Tendering) |
| Capacity | Commitment |
| Spot Market | Spot Market |

Associated with each of these applications are functional requirements. A description of some of these function requirements is included in the following description of the system. A more detailed list of functional requirements for the CShipper and CRetailer software component is included in Appendix A.

The CIntermodal software component allows third party logistics (3PL) companies to fully manage intermodal shipments. Acting as a broker between shipper and multiple carriers, 3PLs can use CIntermodal to manage their dispatches while at the same time perform data exchange transactions with their contracted shippers/retailers/carriers. Other functions incorporated in this software package include: reporting mechanisms and EDI specifications, carriers/credit information, review of delivery issues, shippers profile and rating, planning tools, visibility of orders and commitment, asset unitization program, centralized paperwork access, repositioning opportunities report, bobtailing and deadhead lanes, dwell time analysis, available equipment by desirable lanes, access to spot market and dynamic pricing, cash flow projections and analysis, single source for freight payment from shipper and turnaround on billing cycle.

The CIntermodal software components includes various modules and applications as listed below:

| Module | Application |
|---|---|
| Desktop | Service Message/Alerts |
| Accounts | Company Setup |
| | User Access (Session) |
| | User Access (Setup) |
| | Equipment |
| | Location Setup |
| | Lanes Setup |
| | Event Setup |
| | Contract Setup |
| | Pool Setup |
| | Routing Setup |
| Shipment | Order (Tendering) |
| Customer Service | Pending Dispatch |
| | Open Dispatch |
| Capacity | Commitment |
| Shipment Management | Shipment Management |
| Billing | Invoicing |
| | Carrier Pay |
| | Reports |
| Spot Market | Spot Market |

Associated with each of these applications are functional requirements. A description of some of these function requirements is included in the following description of the system. A more detailed complete list of functional requirements for the CIntermodal software components is included in Appendix A.

The CAdmin software component allows system/account administrators to perform key functions to support the business model (e.g. create a carrier record in ‘Company Setup’) as well as to view, create or edit all system records across all participating companies.

The CAdmin software components includes various modules and applications as listed below:

| Module | Application |
|---|---|
| Desktop | Shipment |
| | Exception Message/Alerts |
| | Freight Payment |
| | Orders |
| Accounts | Company Setup |
| | User Access (Session) |
| | User Access (Setup) |
| | Equipment |
| | Power |
| | Location Setup |
| | Lanes Setup |
| | Event Setup |
| | Contract Setup |
| | Pool Setup |
| | Routing Setup |
| Shipment | Order |
| Customer Service | Pending Dispatch |
| | Open Dispatch |
| Dispatch | Ready Dispatch |
| | Power Capacity |
| Capacity | Commitment & Capacity |
| Shipment Management | Shipment Management |
| Billing | Invoicing |
| | Driver/Carrier Pay |
| | Reports |
| Spot Market | Spot Market |

Associated with each of these applications are functional requirements. A description of some of these function requirements is included in the following description of the system. A more detailed complete list of functional requirements for the CAdmin software components is included in Appendix A.

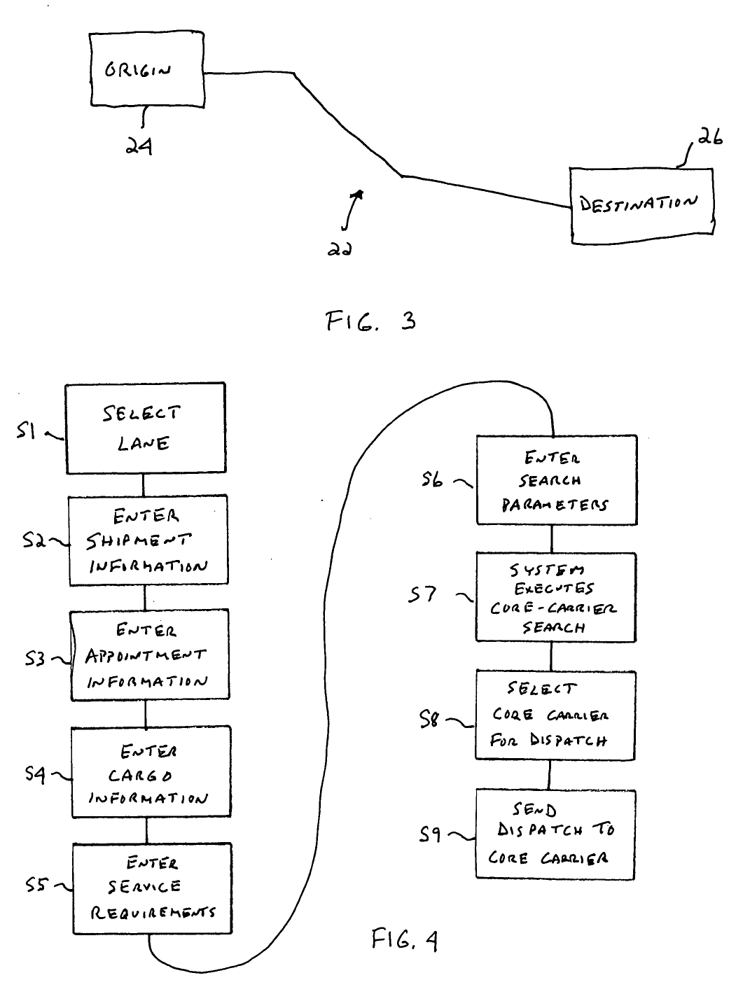

With continued reference to FIG. 1, resident with the main server 16 is a database (not shown) that stores information related to the shippers, retailers, carriers and 3PLs. Included in this data are the lanes along which a shipper/retailer needs to transport goods. As shown in FIG. 3, a lane 22 is a logical travel route between an origin 24 and a destination 26. The data associated with a lane is described in detail in the lane setup application in Appendix A. In addition to the origin/destination data for a lane, this data also includes the transport requirements of the shipper/receiver in relation to each particular lane. These transport requirements includes the mode of transportation (over the road, intermodal), equipment type (trailer, container) and equipment requirements (reefer, vented or dry) necessary to transport the goods. For a single lane a shipper/retailer may have multiple requirements and thus may create multiple versions of a lane.

Also stored in the database is contract information indicative of a contractual relationship between a particular carrier and shipper/retailer. Examples of contractual information is contained in the contract setup application in Appendix A. The existence of a contract between a carrier and a shipper/retailer establishes that carrier as a “core carrier” for that shipper/retailer. The system stores data on many carriers and shipper/retailers. However, each carrier does not necessarily have a contract with each shipper/retailer. Thus, for example, out of twenty carriers associated with the system, a particular shipper/retailer may have contracts with only five carriers or 3PLs. These five carriers or 3PLs are a subset of all carriers and are the “core carriers” for that shipper/retailer.

The database also stores data indicative of a commitment which a shipper/retailer makes to a particular carrier. “Commitment” is made as a number of forecasted orders a shipper/retailer expects to give to a carrier for a particular lane within a specific time period or on a periodic basis. The carrier in turn provides capacity for that commitment. “Capacity” is defined as the number of equipment the carrier wants to be made available to satisfy the commitment made by the shipper/retailer. For example, for each lane, a shipper/retailer may provide a commitment to its core carriers as to the quantity of shipment orders the shipper/retailer expects to tender to the carrier on a weekly or daily basis. The shipper/retailer can assign a specific number of loads or allocate a percentage of total load to a core carrier.

Using the data included in the database, the system performs searches for core carriers based on shipment orders received from a shipper/retailer and tenders the order to the located core carrier. In operation, a shipper/retailer, i.e., user, accesses the system through its respective portal which is accessed through the user interface 20. System menus and selection screens presented on the user interface 20 provide the means through which the user tenders a shipment order to the system server 16.

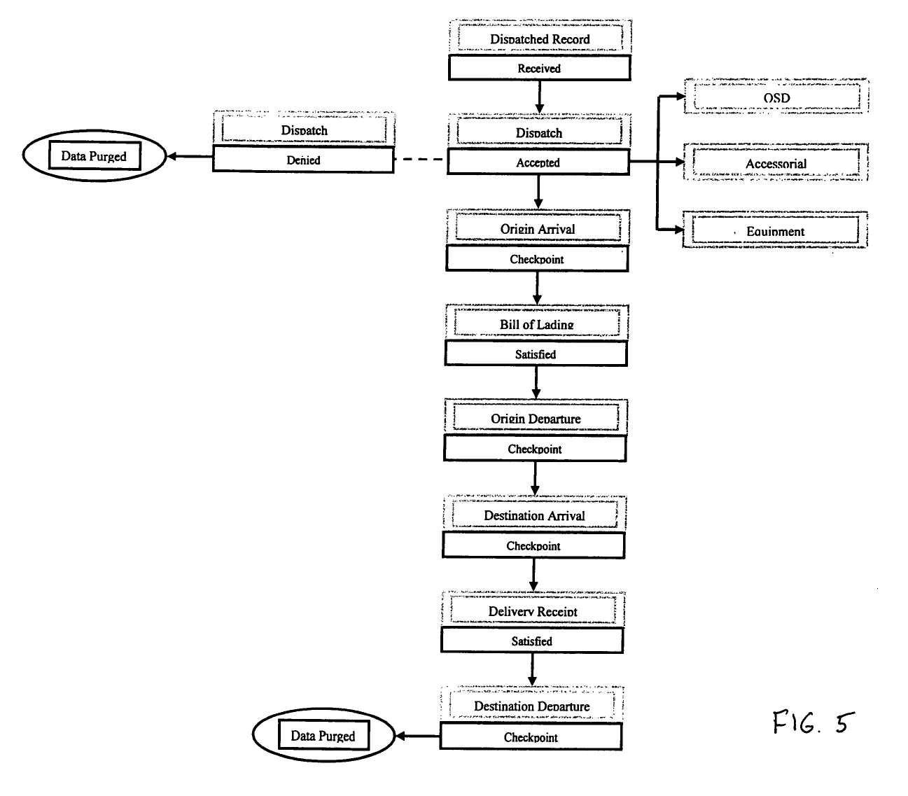

With reference to FIG. 4, at step S1 the user selects a lane for which it wants to create a shipment order. At step S2 the user enters information related to the shipment. Exemplary shipment information is included in the following table.

Shipment General Information

| Field | Type | Example |
|---|---|---|
| Shipment Ref#: | alphanumeric | 37650024422M |
| Shipment Name: | alphanumeric | Hub Group - Chicago |
| Lane Code: | alphanumeric | Chicago-Los Angeles |
| Origin: | Address | 123 Ficus Street, Pomona, |
| | | CA 91792 |
| Destination: | Address | 432 Sheila St, Los Angeles, |
| | | CA 91792 |
| Buyer Name: | alphanumeric | Best Buy Store # 114 |
| Buyer RAD Date: | Date/Military Time | May 20, 2004 6:00 |
| Earliest Ship Date: | Date/Military Time | May 18, 2004 9:47 |
| Latest Ship Date: | Date/Military Time | May 20, 2004 6:00 |
| Master BOL #: | Alphanumeric/special | 42-40462 |
| | characters | |
| Final Destination: | Address | 7710 Formula Place, |
| | | San Diego, CA |
| | | 92121 |

At step S3 the user enters appointment information including pickup and delivery times. A shipment can have multiple appointments for pickups and deliveries and each appointment is considered as a milestone. These milestones, as described later, are tracked by the system. At step S4, the user enters cargo information. Exemplary cargo information follows.

Cargo Information

| | | Must receive approval |
|---|---|---|
| Comments: | Alphanumeric | before . . . |
| Cargo Type: | Drop-Down Menu | TL |
| # of pieces: | Integer | 2000 |
| pieces pallets | Integer | 20 |
| Release Value ($): | Dollar | $450.22 |
| Cube (ft3): | Integer | 53 |
| Weight (lb): | Integer | 2000 |
| HAZMAT: | Boolean | Yes |
| HAZMAT UN#: | Integer | 98830220034 |
| Items(s) Description: | Alphanumeric | |
| Upload Item Information: | Any file type | CARGO.DOC |

At step S5, the user enters service requirements for the shipment. Exemplary shipment requirements include:

Service Requirements

| | | |
|---|---|---|
| Driver Stay-With | Boolean | Yes |
| Driver Unload | Boolean | No |
| Drop and Pull | Boolean | No |
| Load | Boolean | No |
| Lumper Service | Boolean | No |
| Pallet | Boolean | No |
| Pallet Exchange Type | Boolean | No |
| Real-Time Tracking | Boolean | No |
| Teams | Boolean | No |
| Unload | Boolean | No |

At step S6, the user may enter search parameters, such as limiting the search to core carriers or opening the search to all carriers.

At step S7, upon receipt of the foregoing information from the shipper/retailer user interface 16, the system server executes a core-carrier search algorithm. This search process includes searching the database for carriers with which the user has a commitment for the specified lane and an unfilled commitment quantity. An unfilled commitment means that the user has not yet fulfilled its forecasted orders to a particular carrier. Once the relevant carriers are located, the system server 16 outputs data to the user interface 20 that indicates to the user the core carrier and the unfilled commitment quantity. The core carriers may be presented to the user interface in order of unfilled commitment quantity, either from highest to lowest or vise versa. Alternatively, the system may present to the user interface only the core carrier with the highest unfilled commitment quantity.

At step S8, once the core carriers are provided to the shipper/retailer user interface 20, the user selects one of the located core carriers for the particular shipment and requests, through the user interface, a dispatch of the shipment to the core carrier. At step S9, the system server 16 receives data indicative of the dispatch request and sends the dispatch, including any ancillary order information, e.g., shipment information, appointment information, cargo information, etc., to the core carrier system 11. The core carrier system 11 receives the dispatch through the CDashboard portal at its user interface 20. The system server 16, subsequently receives data back from the carrier user interface 20 indicative of whether the dispatch was accepted or rejected by the core carrier and notifies the shipper/retailer of the acceptance or rejection of the dispatch by sending data indicative of such acceptance or rejection to the shipper/retailer system 10, 13.

In an alternative search process, the system server 16 first searches for core carriers and if none are located it searches all remaining carriers in its database, using the same data used to perform the core-carrier search, for a carrier capable of handling the shipment order. The search of remaining carriers not associated with the shipper/retailer by a preexisting contract or commitment is referred to as a “spot market” search. The term “spot market” is used in the transportation industry to refer to transportation service levels and rates associated with having to pay the market rate on a shipment which was previously unforeseen and/or not pre-negotiated between a shipper/retailer and a carrier.

In order to facilitate a spot market search, the system stores data indicative of a carrier's spot market parameters. These parameters include: service area, lanes, rate transport type, equipment requirements, transport time and capacity. All lanes created by all shippers are seen by all carriers with access to the spot market. The creator of the lane (i.e., the shipper), however, remains anonymous. In addition, the spot market permits carriers and 3PLs to create lanes as well. Given this scenario, carriers effect a Boolean value (Yes or No) as to whether or not it supports the lanes listed in spot market. As such, when a shipper selects a lane the system is able to find many to one matches (i.e., carriers supporting this lane). This data is provided to the system through the carrier user terminal 20 and may have an associated expiration date and/or time, as defined by the transport time. For example, a carrier may have power and equipment in a particular service area or near a particular lane that will be available for a limited period of time, perhaps only 12 hours. The carrier may post this power/capacity for specific routes on the spot market for viewing by shippers/retailers on the network. This allows carriers to put out their own competitive prices, power/capacity that needs to go a specific direction but has no load assigned. Shippers or retailers, who may be having commitment issues to handle their shipments, now can bid for this available capacity.

If the selected spot market carrier accepts the dispatch, the system facilitates the formation of a contract or shipment agreement between the carrier and the shipper/retailer. The system is able to perform dynamic contracting by mandating critical document review/accept processes into the spot market workflow. For example, prior to tendering an order to a carrier, the shipper must review and accept the carrier's insurance credentials. Also, prior to accepting a tendered order, the carrier must review and accept the terms of the shipper's contract.

The system is also programmed to execute an exclusive spot market search. Under this search process, the shipper/retailer enters search parameters which may include service area, lane, rate it is seeking to pay, transport type required for the cargo, equipment requirements, transport time and capacity. A lane may be selected from a ‘Lanes Listing’ which exists in the system as described above or the shipper may create another lane (using addresses) and request a “match to similar or closest” lane. The system then searches all carriers, including the shipper/retailer's core carriers, for a carrier that has posted a power/capacity capable of handling the shipment and that is both within the specified service area and/or lane and falls within the rate specified by the shipper/retailer. Alternatively, the system may provide a list of carriers with the variance (plus or minus) in offered rate. Carriers located by the exclusive spot market search are presented to the shipper/retailer user interface 20 and the selection process by the shipper/retailer proceeds as previously described with respect to the core carrier search.

With reference to FIG. 1, also include in the system are various driver applications which may be resident, for example, in a wireless handheld device 28 such as a PDA that is co-located with the shipment. The wireless device 28 interfaces with the main server 16 over a wireless link 32 and, as described in detail below, provides shipment related information to the server 16.

The driver application, also referred to as the CWireless™ software component includes various modules and applications as listed below:

| Module | Application |
|---|---|
| Dispatch | Dispatch |
| Checkpoint | Origin/Destination Arrival/Departure Status |
| Bill of Lading | Trailer Information |
| | O/D Information |
| | Shipment Reference # |
| | Weight Information |
| | Seal Information |
| | Pallet Information |
| | Piece Information |
| | HazMat Information |
| | Special Requirements |
| | Instruction Information |
| OSDs | Overage |
| | Shortage |
| | Damage |
| Accessorial | Accessorial |
| Equipment | Equipment |
| Delivery Receipt | Delivery Receipt |

Associated with each of these applications are functional requirements. A description of some of these function requirements is included in the following description of the system. A complete list of functional requirements for the CWireless software component is included in Appendix A.

The driver applications incorporates fundamental workflows associated with dispatching and shipment management over a technical platform enabling Image-capturing and GPS technology. A wireless/WAN collaboration institutes a topology of rules-based algorithms that forecast “lane passing,” i.e., the average travel time between and origin and a destination (O/D) and continuously track assets throughout each O/D pair; resulting in alerting concerned parties of potential delays. Below is a table summarizing these aspects of the system.

Driver Applications Function Table

| Technology | Applications | Functions |
|---|---|---|
| Workflow | All applications | Driver workflow enforces complete Dispatch |
| | | before BoL, before OSD, before Delivery, etc. |
| | | Server workflow includes seamless 3-party |
| | | processing of OSD and Accessorial dispositions. |
| Alerts | Dispatch notifications | Dispatch users are informed of driver or shipment |
| | | activity via Dashboard alerts |
| | | Console alerts complete seamless macro- |
| | | collaboration for augmented workflow. |
| Messages | Driver notifications | Drivers are informed of dispatch or record activity |
| | | via Message. (e.g. Accessorial approved, etc . . . ) |
| | | Email messages accommodate voice-messaging |
| PhotoDoc | OSD | OSD image snapshot/attach/send |
| (image capture) | Accessorial | Accessorial snapshot/attach/send |
| | Equipment | Equipment snapshot/attach/send |
| | Delivery Rcpt. | Delivery Rcpt. snapshot/attach/send |
| | | Video capture w/voice |
| GPS/ | Dispatch acceptance | Accept dispatch is stamped by GPS and time |
| Timestamp | Dispatch Origin | Origin in/out is stamped by GPS and time |
| | Dispatch Destination | Destination in/out is stamped by GPS and time |
| | | Wireless application automatically (at intervals of |
| | | <n> minutes) logs GPS (long/lat) position of |
| | | driver/tractor and reports to central server. |
| Rules | All applications | Workflow is enforced, requiring the Driver to |
| | | complete sections of the record before effecting |
| | | changes to the next. |
| | | Interruptions in network during data broadcast |
| | | give rise to Driver alerts, informing he/she that the |
| | | record can not be transmitted back until network |
| | | connectivity is restored. |
| | | Long/lat of each Origin and Destination is set in |
| | | system. |
| | | System auto-tracks (via GPS) average drive time |
| | | between OD pairs by calculating Mean average of |
| | | tracked drive times. |
| | | System auto-tracks average 1 hour checkpoints |
| | | (via GPS) of shipments between OD Pairs, by |
| | | calculating Mean average of 1 hour checkpoints. |
| | | System auto-tracks progress of dispatch against |
| | | averages via GPS position and progress of |
| | | shipment. |
| | | System auto-tracks shipment OD departures and |
| | | arrivals via GPS position and progress of shipment |
| | | System alerts dispatch of schedule slip, asks |
| | | driver for reason. |
| | | System authenticates shipment movement, logs it |
| | | on Invoice. |
| | | System auto-updates Power and Driver tables of |
| | | each driver's position (via GPS), allowing system |
| | | to recommend optimum Power/Driver for pending |
| | | dispatches. |

One function of the driver applications is to provide the system with an enforcement model that allows the system to monitor and control the transport of goods between an origin and destination. During a typical shipment cycle, a carrier accepts a dispatch and arrives at the origin to pick up the shipment. At the origin, a bill of lading (BoL) is reviewed by carrier personal, i.e., the driver, and any discrepancies between the BoL and the shipment are noted by the driver. The carrier then departs from the origin for the destination. Upon arrival at the destination, the shipment is delivered to the recipient and a record of receipt is generated by the driver. After that, the driver departs from the destination.

With reference to FIG. 5, the enforcement model of the system presents various information through the wireless device though different screens and menus at different stages of the shipment cycle. At each stage, the information collected through these screens and menus is either stored in the wireless device or transmitted back to the main server 16. The system is configured such that the screens and menus relevant to one stage of the shipment cycle are not presented through the wireless device until sufficient information is collected with respect to the current stage of the shipment cycle. Thus, for example, the system prevents the wireless device from viewing or processing a BoL, or from checking in at the origin, until the shipment dispatch has been accepted and data indicative of such acceptance has been received by the system. As used herein, “received by the system,” may mean either receipt by the wireless device or receipt by the main server or possibly some intermediate device between the wireless device and the main server.

The system may also prevent the wireless device from accessing an origin departure screen or accepting origin departure information until after information related to the BoL has been received by the system. Other enforcement models: prevent access to a destination arrival screen or acceptance of destination arrival information until after information related to the departure from an origin has been received by the system, prevent access to a delivery receipt screen or acceptance of related information until after the receipt of destination arrival information and, prevent access to a destination departure screen or acceptance of related information until after the receipt of information indicative of a satisfactory delivery receipt.

Details of the various block of the enforcement model shown in FIG. 5, as included in the appendices listed below:

Dispatch Record received—Appendix B

Dispatch accepted—Appendix B

Origin Arrival checkpoint—Appendix C

Bill of Lading satisfied—Appendix D

Origin Departure checkpoint—Appendix C

Destination Arrival checkpoint—Appendix C

Delivery Receipt satisfied—Appendix E

Destination Departure checkpoint—Appendix D

Overage, Shortage, Damage (OSD)—Appendix F

Accessorial—Appendix G

Equipment—Appendix H

In one embodiment of the system, the wireless device include image capture capabilities, such as a digital camera, that allows for the capture and sending of images over the system. For example, as indicated in the preceding driver applications functions table, images may be captured during the OSD, accessorial, equipment and delivery receipt applications. Examples of accessorial images include mechanical breakdown, equipment images include damaged trailer at pick up, OSD images include damaged pallet of product and delivery receipt images include signed delivery receipt document, bill of lading, order, etc.

In another function of the driver applications component of the system, the wireless device is configured to receive application messages from the carrier's user terminal 20 through the main server 16. Among other functions, the server 16 is programmed to monitor the time it takes for the wireless device to receive the application message and if the application message is not received by the wireless device after a specified amount of time, to cause an alert notification to be presented through the carrier's user terminal. Details of these function of the system are included in Appendix I.

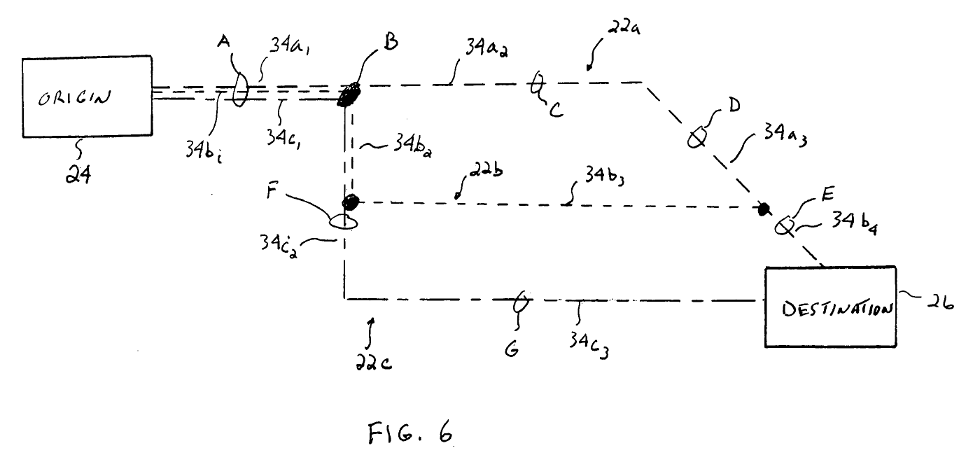

As another function, the driver applications component of the system provides for the monitoring of the transport of goods from origin to destination. With reference to FIG. 6, between an origin 24 and a destination 26, there may be a number of possible transit routes 22a, 22b, 22c. Stored within the system database is data indicative of the average time it takes to travel from the origin 24 to the destination 26 along a particular transit route 22a, 22b, 22c. The system divides each of the transit routes 22 into segments 34 and data indicative of the average time it is expected to travel each segment of a particular transit route is also stored in the database.

During transport of a shipment, the system periodically receives data indicative of the location of the shipment and the time at the location. This data is provided by a location tracking device within the handheld device that includes the driver applications. This handheld device is usually carried by the driver. In a preferred configuration, the tracking device is a GPS device that periodically transmits GPS data from which the location of the shipment and associated time may be determined.

The system receives and stores the periodic location and time data. The system monitors the data and determines when a segment 34 of the transit route 22 has been completed, determines the total time taken to travel that segment and compares the determined time to the expected time stored in the database to determine a time differential or variance. If the determined travel time for a segment 34 exceeds the expected time by the threshold amount, a notification output is sent to the shipper/retailer. For example, if the actual time exceeds the expected time by 25%, a notification may be sent. These threshold amounts are stored in the database.

The average travel time along a route may vary depending on the time of day the shipment leaves the origin. For example, the average travel time for segment A of a transit route may be 1.0 hour if the departure time from the origin is 6:00 am, while the average time for the same segment may be 2.0 hours if the departure time is 11:00 am. The system accounts for these possible variables in average travel time by storing expected average time data for each departure time.

The system is also programmed to collect data on the average travel times and departure times of the various carriers along a transit route. Using this data, the system periodically calculates the overall average travel time in relation to a particular departure time or range of departure times, e.g., between 6:00 am and 7:00 am, among the carriers and replaces the existing expected average travel time with the newly calculated expected average travel time. Thus, the system record of the expected average travel times is kept up to date. Average Travel times are stored in twelve separate periods (one for each month) thereby allowing the average travel calculation algorithm to consider the conditions (weather, traffic) associated with seasonal shifts.

At times during the transport of a shipment, the transit route may change, for example, due to traffic conditions. With reference to FIG. 6, two or more different transit routes 22a, 22b, 22c may connect an origin 24 and a destination 26. In some instances, these transit routes may share common segments. For example, transit routes 22a and 22c both include segment A which originates at the origin 24. The transit routes then diverge at point B with segments C, D and E completing route 22a and segments F and G completing route 22b. In accordance with another feature of the system, the location data provided by the wireless device is used by the system to determine which route is being traveled and the corresponding time differentials are determined accordingly. Thus, in the example shown in FIG. 6, the system determines the time variance, if any, between actual travel time and expected travel time with respect to segment A. Then, depending on subsequent location data received by the system, it determines the time variance with respect to either segment C or F. If it is determined that transit route 22a is being traveled then the system eventually determined the time variance with respect to segments D and E. If it is determined that transit route 22c is being traveled then the system eventually determined the time variance with respect to segments F and G.

The time variance data collected by the system is used to calculate a rating for each of the carriers who service a particular lane. Using this data, the system periodically calculates the average time it takes a carrier to travel along a lane between an origin and a destination. For each lane, the system then compares the times of all carriers and assigns a score to the carrier based on its time relative to the times of other carriers. The system may also provide an overall score for the carrier by calculating the average scores of the carrier across all of the lanes it services.

The scoring algorithm is based on timeliness of gate arrival. A carrier's score is ‘Per Lane.’ Thus, a particular carrier may have a 5 star rating for one particular lane but only 1 star rating for another lane. An example algorithm is provided:
1) Each carrier begins with 1000 points, for each lane served
2) Lane shipment timeliness is monitored and scored as such: (origin appt−origin in-gate actual)+(destination appt−destination in-gate actual)×−1
3) Points accumulated are deducted from running total.
4) Points scored are visually displayed as Stars. As such:
   >1000=1 Star (*)
   750-1000=2 Star (**)
   500-749=3 Star (***)
   250-499=4 Star (****)
   <250=5 Star (*****)

Throughout the various system processes and functions, the information and data collected by the various system components is made of record in the system database. Details on the recordation of data is included in Appendix J.

With reference to FIG. 1, the system server 16 may also interface with fixed applications, e.g., hard-mounted trailer tracking and status devices, to provide a means of integrating the information provided by these applications into the system. For example, location data provided by a device mounted to a trailer may be used to track the shipment in a manner similar to the location data provided by the handheld wireless appliance.

It will be apparent from the foregoing that while particular forms of the invention have been illustrated and described, various modifications can be made without departing from the spirit and scope of the invention. Accordingly, it is not intended that the invention be limited, except as by the appended claims.

What is claimed is:

1. A method of using a computer network including a server, database and user terminal to arrange for the shipment of goods for the benefit of a party, said method comprising:
associating in the database, the party with a plurality of lanes along which the party may desire to transport goods;
associating in the database, a plurality of core service providers with the party, the association including data indicative of a commitment of a quantity of shipment orders the party expects to dispatch to the core provider for a particular lane;
presenting at the user terminal, a shipment order screen including a menu of the lanes associated with the party;
receiving at the server, a shipment order from the user terminal including data indicative of a selected lane;
searching the database for core service providers with which the party has an unfilled commitment quantity for the selected lane; and
outputting to the user terminal, data indicative of the located core service providers.

2. The method of claim 1 further comprising, associating in the database, transport capability requirements with the lanes associated with the party.

3. The method of claim 2 wherein the transport capability requirements includes mode of transportation, equipment type and equipment requirement.

4. The method of claim 1 wherein the shipment order screen further includes a menu of ancillary order information comprising at least one of shipment information, appointment information, cargo information, equipment requirement information and service requirement information.

5. The method of claim 1 wherein the commitment of a quantity comprises a number of shipment orders within a time period.

6. The method of claim 1 wherein the commitment of a quantity comprises a percentage of shipment orders within a time period.

7. The method of claim 1 wherein data indicative of the located core service providers comprises data indicative of unfilled commitment quantity.

8. The method of claim 1 wherein associating a plurality of core service providers with the party comprises storing data in the database indicative of a contract between the core service providers and the party for the lane.

9. The method of claim 10 wherein the contract information comprises service provider rates and the method further comprises outputting to the user terminal the rates associated with the located core service providers.

10. A system for arranging for the shipment of goods for the benefit of a party, said system comprising:
a database including a first database component associating the party with a plurality of lanes along which the party may desire to transport goods and a second database component associating a plurality of core service providers with the party, the association including data indicative of a commitment of a quantity of shipment orders the party expects to dispatch to the core provider for a particular lane;
a user terminal programmed to present a shipment order screen including a menu of the lanes associated with the party and to output data indicative of a shipment order; and
a server programmed to:
receive the shipment order from the user terminal including data indicative of a selected lane;
search the database for core service providers with which the party has an unfilled commitment quantity for the selected lane; and
output to the user terminal, data indicative of the located core service providers.

11. A computer-readable medium having computer-executable instructions for performing a method comprising:
associating a party with a plurality of lanes along which the party may desire to transport goods;
associating a plurality of core service providers with the party, the association including data indicative of a commitment of a quantity of shipment orders the party expects to dispatch to the core provider for a particular lane;
presenting a shipment order screen including a menu of the lanes associated with the party;
in response to a lane selection, searching the database for core service providers with which the party has an unfilled commitment quantity for the selected lane; and
outputting data indicative of the located core service providers.

12. A method of using a computer network including a server, database and user terminal to arrange for the shipment of goods for the benefit of a party, said method comprising:
associating in the database, the party with a plurality of lanes along which the party may desire to transport goods, each lane having further associated transport capability requirements;
associating in the database, a plurality of core service providers with the party;
associating in the database, a plurality of spot market service providers with data indicative of spot market parameters including lanes serviced and at least one of rate, transport type, equipment type, transport time and capacity;
presenting at the user terminal, a shipment order screen including a menu of the lanes associated with the party;
receiving at the server, a shipment order from the user terminal including data indicative of a selected lane;
searching the database for core service providers associated with the party based on the selected lane;
if no core service provider is located, searching for spot market service providers based on the selected lane and its associated transport capability requirements; and
outputting to the user terminal, data indicative of the located service providers.

13. The method of claim 12 wherein the transport capabilities includes mode of transportation, equipment type and equipment-requirement capabilities available from the service provider on the lane.

14. The method of claim 12 wherein the transport requirements include mode of transport, equipment type and equipment requirement.

15. The method of claim 12 wherein the association between the party and the core service providers includes data indicative of a commitment of a quantity of shipment orders the party expects to dispatch to the core provider for a lane and searching further comprises searching the database for core service providers with which the party has an unfilled commitment quantity.

16. The method of claim 15 further comprising storing in the database, data indicative of a quantity of shipment orders the party expects to dispatch to spot market service providers.

17. A system for arranging for the shipment of goods for the benefit of a party, said system comprising:
a database including a first database component associating the party with a plurality of lanes along which the party may desire to transport goods, each lane having further associated transport capability requirements, a second database component associating a plurality of core service providers with the party and a third database component associating a plurality of spot market service providers with data indicative of spot market parameters including lanes serviced and at least one of rate, transport type, equipment type, transport time and capacity;
a user terminal programmed to present a shipment order screen including a menu of the lanes associated with the party and to output data indicative of a shipment order; and
a server programmed to:
receive a shipment order from the user terminal including data indicative of a selected lane;
search the database for core service providers associated with the party based on the selected lane;
if no core service provider is located, search for spot market service providers based on the selected lane and its associated transport capability requirements; and
output to the user terminal, data indicative of the located service providers.

18. A computer-readable medium having computer-executable instructions for performing a method comprising:
associating a plurality of core service providers with the party;
associating a plurality of spot market service providers with data indicative of spot market parameters including lanes serviced and at least one of rate, transport type, equipment type, transport time and capacity;
presenting a shipment order screen including a menu of the lanes associated with the party;
in response to a lane selection, searching the database for core service providers associated with the party based on the selected lane;
if no core service provider is located, searching for spot market service providers based on the selected lane and its associated transport capability requirements; and
outputting data indicative of the located service providers.

19. A method of using a computer network including a server, database and user terminal to arrange for the shipment of goods for the benefit of a party, said method comprising:
associating in the database, the party with a plurality of lanes along which the party may desire to transport goods, each lane having further associated transport capability requirements and service areas;
associating in the database, a plurality of spot market service providers with data indicative of spot market parameters including lanes serviced and at least one of rate, transport type, equipment type, transport time and capacity;
presenting at the user terminal, a shipment order screen including a menu of the lanes associated with the party;
receiving at the server, a shipment order from the user terminal including data indicative of a selected lane;
searching the database for spot market service providers based on the selected lane and its associated transport capability requirements and service areas; and
outputting to the user terminal, data indicative of the located service providers.

20. A system for arranging for the shipment of goods for the benefit of a party, said system comprising:
a database including a first database component associating the party with a plurality of lanes along which the party may desire to transport goods, each lane having further associated transport capability requirements and service areas and a second database component associating a plurality of spot market service providers with data indicative of spot market parameters including lanes serviced and at least one of rate, transport type, equipment type, transport time and capacity;
a user terminal programmed to present a shipment order screen including a menu of the lanes associated with the party; and
a server programmed to:
receive a shipment order from the user terminal including data indicative of a selected lane;
search the database for spot market service providers based on the selected lane and its associated transport capability requirements and service areas; and
output to the user terminal, data indicative of the located service providers.

21. A computer-readable medium having computer-executable instructions for performing a method comprising:
associating a party with a plurality of lanes along which the party may desire to transport goods, each lane having further associated transport capability requirements and service areas;
associating a plurality of spot market service providers with data indicative of spot market parameters including lanes serviced and at least one of rate, transport type, equipment type, transport time and capacity;
presenting a shipment order screen including a menu of the lanes associated with the party;
in response to a lane selection, searching the database for spot market service providers based on the selected lane and its associated transport capability requirements and service areas; and
outputting to the user terminal, data indicative of the located service providers.

22. A method of monitoring the transport of goods for the benefit of a party between an origin and a destination over a computer network including a server, database and user terminal accessible by the party, said method comprising:
storing data in the database indicative of the expected average transit times from the origin to the destination along a transit route having a plurality of segments, including expected average times to travel the entire route and expected average times to travel the segments;
periodically receiving data indicative of the location of the goods and the time at the location;
based on the location and time data, determining the segment of the transit route traveled and the time taken to travel that segment;
comparing the determined time with the expected time associated with the determined transit route segment; and
outputting a notification to the user terminal if the determined time exceeds the expected time by a threshold value.

23. The method of claim 22 wherein periodically receiving location and time data from the goods comprises:
associating a location tracking device with the goods; and
transmitting the location and time data using the tracking device.

24. The method of claim 23 wherein the tracking device is a GPS device.

25. The method of claim 22 wherein the expected average times stored in the database have an associated time of departure from the origin and the method further comprises:
receiving data indicative of the time of departure of the goods from the origin and
comparing the determined time with the expected time associated with the determined transit route segment and the time of departure.

26. The method of claim 22 wherein storing data comprises:
collecting transit time data for a transit route over a period of time;
calculating the average time using the collected data; and
storing the average time in the data base as the expected average time.

27. The method of claim 22 wherein the period of time comprises a seasonal component and the data stored in the database includes expected average times for each seasonal component.

28. The method of claim 27 wherein the seasonal component comprises a calendar month.

29. A system for monitoring the transport of goods for the benefit of a party between an origin and a destination, said system comprising:
a user terminal accessible by the party;
a database including data indicative of the expected average transit times from the origin to the destination along a transit route having a plurality of segments, including expected average times to travel the entire route and expected average times to travel the segments; and
a server programmed to:
periodically receive data indicative of the location of the goods and the time at the location;
based on the location and time data, determine the segment of the transit route traveled and the time taken to travel that segment;
compare the determined time with the expected time associated with the determined transit route segment; and
output a notification to the user terminal if the determined time exceeds the expected time by a threshold value.

30. A computer-readable medium having computer-executable instructions for performing a method in conjunction with a database including data indicative of the expected average transit times from the origin to the destination along a transit route having a plurality of segments, including expected average times to travel the entire route and expected average times to travel the segments, said method comprising:
based on data indicative of the location of the goods and the time at the location, determining the segment of the transit route traveled and the time taken to travel that segment;
comparing the determined time with the expected time associated with the determined transit route segment; and
outputting a notification if the determined time exceeds the expected time by a threshold value.

31. A method of monitoring the transport of goods for the benefit of a party between an origin and a destination over a computer network including a server, database and user terminal accessible to be party, said method comprising:
storing data in the database indicative of the expected average transit times from the origin to the destination along a plurality of transit routes each having a plurality of segments, including expected average times to travel the entire route and expected average times to travel the segments;
periodically receiving data indicative of the location of the goods and the time at the location;
based on the location and time data, determining the transit route being traveled, the segment of the transit route being traveled and the time taken to travel that segment;
comparing the determined time with the expected time associated with the determined transit route segment; and
outputting a notification to the user terminal if the determined time exceeds the expected time by a threshold value.

32. A system for monitoring the transport of goods for the benefit of a party between an origin and a destination, said system comprising:
a user terminal accessible by the party;
a database including data indicative of the expected average transit times from the origin to the destination along a plurality of transit routes each having a plurality of segments, including expected average times to travel the entire route and expected average times to travel the segments; and
a server programmed to:
periodically receive data indicative of the location of the goods and the time at the location;
based on the location and time data, determine the transit route being traveled, the segment of the transit route being traveled and the time taken to travel that segment;
compare the determined time with the expected time associated with the determined transit route segment; and
output a notification to the user terminal if the determined time exceeds the expected time by a threshold value.

33. A computer-readable medium having computer-executable instructions for performing a method in conjunction with a database including data indicative of the expected average transit times from the origin to the destination along a plurality of transit routes each having a plurality of segments, including expected average times to travel the entire route and expected average times to travel the segments, said method comprising:
in response to data indicative of the location of the goods and the time at the location, determining the transit route being traveled, the segment of the transit route being traveled and the time taken to travel that segment;
comparing the determined time with the expected time associated with the determined transit route segment; and
outputting a notification if the determined time exceeds the expected time by a threshold value.

34. A method of collecting and presenting data related to the transport of goods by a service provider between an origin and a destination using a computer network including a server, database and user terminal, said method comprising:
receiving at the network, data indicative of the time the service provider arrived at the origin;
receiving at the network, data indicative of the time the service provider arrived at the destination;
comparing the origin arrival time with an origin appointment time;
comparing the destination arrival time with a destination appointment time; and
assigning a rating to the service provider based on the comparison.

35. The method of claim 34 wherein assigning a rating comprises:
assigning a running total point value to a service provider;
determining a point value using the comparisons; and
adjusting the running total point value by the determined point value.

36. The method of claim 35 further comprising associating a rating indicator with the running total point value.

37. A system for collecting and presenting data related to the transport of goods by a service provider between an origin and a destination, said system comprising:
a transmitter for transmitting data indicative of the time the service provider arrived at the origin and the time the service provider arrived at the destination;
a server in communication with the transmitter to receive the transmitted data and programmed to:
compare the origin arrival time with an origin appointment time;
compare the destination arrival time with a destination appointment time; and
assign a rating to the service provider based on the comparison.

38. A computer-readable medium having computer-executable instructions for performing a method comprising:
receiving data indicative of the time the service provider arrived at the origin;
receiving data indicative of the time the service provider arrived at the destination;
comparing the origin arrival time with an origin appointment time;
comparing the destination arrival time with a destination appointment time; and
assigning a rating to the service provider based on the comparison.

39. A method of monitoring and managing the shipment of goods on a piece of equipment from an origin to a destination using a computer network including a server and a wireless communications device associated with the equipment, said method comprising:
transmitting notification data of an assigned dispatch from the server to the wireless device;
upon receipt of the notification data, presenting at the wireless device a user interface including a notification menu including a dispatch summary and a means to access full dispatch details;
at the wireless device, assembling data indicative of user interaction with the notification menu including an acceptance or rejection of the dispatch and transmitting the data to the server;
at the server, reading the acceptance/rejection data and, if the data is indicative of an acceptance, allowing downloading of the full dispatch details to the wireless device, if the data is indicative of a rejection, preventing downloading of the full dispatch details to the wireless device;
upon acceptance of the dispatch, presenting at the wireless device a user interface including an origin arrival checkpoint menu, assembling data indicative of user interaction with the menu representing arrival at the origin and sending origin arrival data to the server including a dispatch identifier, GPS data and a timestamp
upon sending origin arrival information to the server, presenting at the wireless device a user interface including a bill of lading menu including a plurality of line items, assembling data indicative of a response to each of the line items and sending the data to the server
upon sending the bill of lading data to the server, presenting at the wireless device a user interface including an origin departure checkpoint menu, assembling data indicative of user interaction with the menu representing departure from the origin and sending origin departure data to the server including a dispatch identifier, GPS data and a timestamp
upon sending origin departure data to the server, presenting at the wireless device a user interface including a destination arrival checkpoint menu, assembling data indicative of user interaction with the menu representing arrival at the destination and sending destination arrival data to the server including a dispatch identifier, GPS data and a timestamp
upon sending the destination arrival data to the server, presenting at the wireless device a user interface including a delivery receipt menu, assembling data indicative of user interaction with the menu representing delivery of the shipment at the destination and sending the delivery receipt data to the server including dispatch identifier and recipient name.
upon sending the delivery receipt data to the server, presenting at the wireless device a user interface including a destination departure menu, assembling data indicative of user interaction with the menu representing departure from the destination and sending destination departure data to the server including a dispatch identifier, GPS data and a timestamp.

40. The method of claim 39 further comprising, upon acceptance of the dispatch, presenting at the wireless device a user interface including a shipment condition menu, assembling data indicative of user interaction with the menu representing any one of overage, shortage or damage of the shipment and sending the data to the server including condition type and disposition.

41. The method of claim 40 wherein the data further includes an image of the condition.

42. The method of claim 39 further comprising, upon acceptance of the dispatch, presenting at the wireless device a user interface including an accessorial menu, assembling data indicative of user interaction with the menu representing an accessorial event and sending the data to the server including accessorial type.

43. The method of claim 42 wherein the data further includes an image representative of a mechanical breakdown associated with the equipment.

44. The method of claim 39 further comprising, upon acceptance of the dispatch, presenting at the wireless device a user interface including an equipment issues menu, assembling data indicative of user interaction with the menu representing an equipment issue and sending the data to the server including equipment type.

45. The method of claim 44 wherein the data further includes an image of physical damage associated with the equipment.

46. The method of claim 39 wherein the delivery receipt data further includes an image of delivery related documents including any one of a signed delivery receipt, a bill of lading and an order.
